(19) United States
(12) Patent Application Publication
(10) Pub. No.: US 2003/0194303 A1
(43) Pub. Date: Oct. 16, 2003

(54) Hand-operated lifting/transportation device

(76) Inventor: Joel G. Lunger, Sparta, MI (US)

Correspondence Address: Warner Norcross & Judd LLP, 900 Fifth Third Center, 111 Lyon Street, N.W., Grand Rapids, MI, 49503-2487, US

(21) Appl. No.: 10/122,622

(22) Filed: Apr. 15, 2002

(51) Int. Cl. B62B 1/06

(52) U.S. Cl. 414/444

(57) ABSTRACT

A wheeled lifting device particularly well suited for lifting a stack of nested waste containers. The device includes a lift arm, a handle, and a pair of wheels. The wheels move in an under-center action under the lift arm to lift one side of a stack of containers. When the stack is so lifted it is supported for rolling movement on the wheels of the device and on the wheels of the lower-most container.

### BACKGROUND OF INVENTION

The present invention relates to container support apparatus and, more specifically, to a wheeled carrier for moving stacks of containers.

Various wheeled carriers are known in the prior art. These wheeled carriers, commonly referred to as hand trucks, are typically constructed from metal tubing. A wheeled carrier generally consists of wheels, a support platform, and a handle assembly. A container or other object is placed on the support platform and the user tilts the carrier so only the wheels are in contact with the ground. The user then pulls the carrier to move the container or other object.

Several wheeled carriers have been specifically designed to facilitate the movement of large bins, such as waste receptacles. These wheeled carriers are designed to keep the bin from tipping or sliding during transport. In general, these carriers have attachment devices, such as clamps, that grasp the bin prior to and during transport. Alternatively, the bin may be placed within a frame attached to the carrier. To use the carrier, the bin is lifted and placed on the support platform. If the carrier has a frame, the bin is placed within the frame.

Basic wheeled carriers are effective only when the item to be transported can be lifted and placed on the carrier. However, due to the weight of items needing to be moved in an industrial setting, it is impractical in many instances to lift the item prior to transport. Some wheeled carriers eliminate the support platform. Instead, these wheeled carriers include attachment devices such as clamps to grasp the item prior to transport. After connecting the attachment devices to an item, the wheeled carrier is usually tilted and pulled in the same manner as the prior art wheeled carriers.

These modified wheeled carriers are useful when a section of the item to be transported can be securely clamped. For instance, when transporting a gas cylinder, the attachment device would be connected to the upper rim of the cylinder. In general, only one article can be securely transported on a carrier. Additionally, time must be taken prior to transport to connect the attachment device to the item. Typically, multiple sides of the item must be accessible to connect the attachment device to the item.

In an industrial setting, specifically in the waste receptacle industry, items are often stacked during shipment and storage. A stack of items is generally too heavy to lift and place on a conventional hand truck. Additionally, during transport and storage, the stacks are packed tightly to maximize the use of space. As a result, the modified carriers described above can not be used. Instead, fork lift trucks are commonly used to transport stacks of items. Special lift devices have to be attached to each fork lift truck to allow the fork lift to properly interact with a stack so the stack can be lifted and moved. The special lift devices are expensive, and fork lift trucks are not available at all locations where transport of items is required.

When a fork lift truck is not used, the stacks are generally moved by hand. Generally, personnel must be able to access the sides of a stack to prevent the stack from tipping during movement. Space is left when packing the items to allow personnel sufficient room to move the items manually when necessary. This wasted space is an added expense when storing or shipping items. Additionally, there are significant safety concerns when moving the stacks by hand since stacks can tip.

### SUMMARY OF THE INVENTION

The aforementioned problems are overcome by the present invention wherein a wheeled carrier, or dolly, is provided to interfit with the front of a stack of typical commercial waste receptacles to provide a second set of wheels. When connected to the dolly, both the wheels of the waste receptacle and the wheels of the dolly support the stack for easy, safe, rolling movement.

The dolly includes a container arm for engaging one of the containers. The dolly further includes wheels that, through an “under-center” action, lift the containers slightly. A handle opposite the container arm assists in moving the dolly through its under-center action, and then assists in transporting the containers.

In a preferred embodiment a substantially U-shaped step bar is attached to the base of the handle unit. The step bar allows a user to more easily push the wheels through the under-center action, and thus lift the stack for rolling transport.

In a preferred embodiment, a kick stand is rotatably attached to the step bar. By rotating the kick stand so it is in contact with the ground, the user can rest the dolly in an upright position allowing the dolly to be more easily accessed when needed.

This invention provides a simple and inexpensive dolly for moving stacks of items in a tightly packed space. The lift device interacts with the front of a typical commercial waste receptacle to connect the dolly to the waste receptacle. Once connected, the dolly is designed to lift the stack so only the wheels of the lower-most container of the stack remain in contact with the ground. This configuration allows a stack of receptacles to be moved even if only one side of the stack is accessible. Additionally, the dolly can be easily maneuvered in small, enclosed spaces such as an over-the-road trailer. Since only one side of a stack must be accessed to move the stack, the items can be packed tightly during shipping and storage. This will significantly decrease the costs of shipping and storing items. Further, since the wheels of the dolly and the wheels of the base unit are in contact with the ground, the stack is very stable when being moved.

These and other objects, advantages, and features of the invention will be readily understood and appreciated by reference to the detailed description of the preferred embodiment and the drawings.

### BRIEF DESCRIPTION OF THE DRAWINGS

FIG. 1 is a perspective view of the dolly manufactured and being used in accordance with a preferred embodiment of the present invention;

FIG. 2 is a side view of the dolly;

FIG. 3 is a front view of the dolly;

FIG. 4 is a rear view of the dolly;

FIG. 5 is a side view of the dolly in use;

FIG. 6 is a side view of the dolly in use;

FIG. 7 is a side view of the dolly in use.

### DETAILED DESCRIPTION OF THE PREFERRED EMBODIMENT

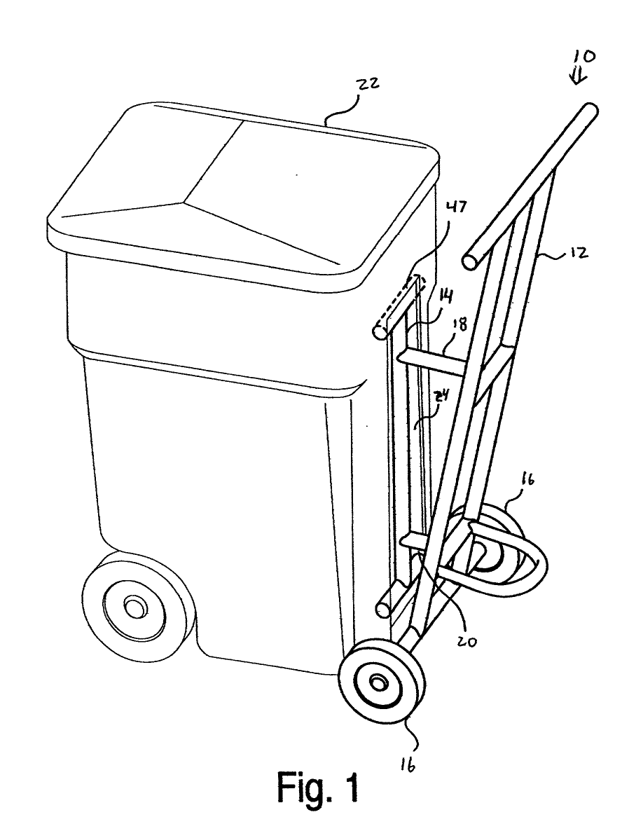

A dolly 10 in accordance with a preferred embodiment of the present invention is shown in FIG. 1. The dolly 10 is generally comprised of a handle unit 12 and a lift unit 14. In a preferred embodiment, wheels 16 are attached to the base of handle unit 12. First attachment bar 18 and second attachment bar 20 connect the lift unit 14 to the handle unit 12. The lift unit 14 is configured to connect with the front side of a typical commercial waste receptacle 22. When the dolly 10 is tilted toward the waste receptacle 22, the lift unit 14 fits within a groove 24 running along the front of the waste receptacle 22. While the invention will be described in relation to use with standard commercial waste receptacles, the present invention is well suited for use with other items.

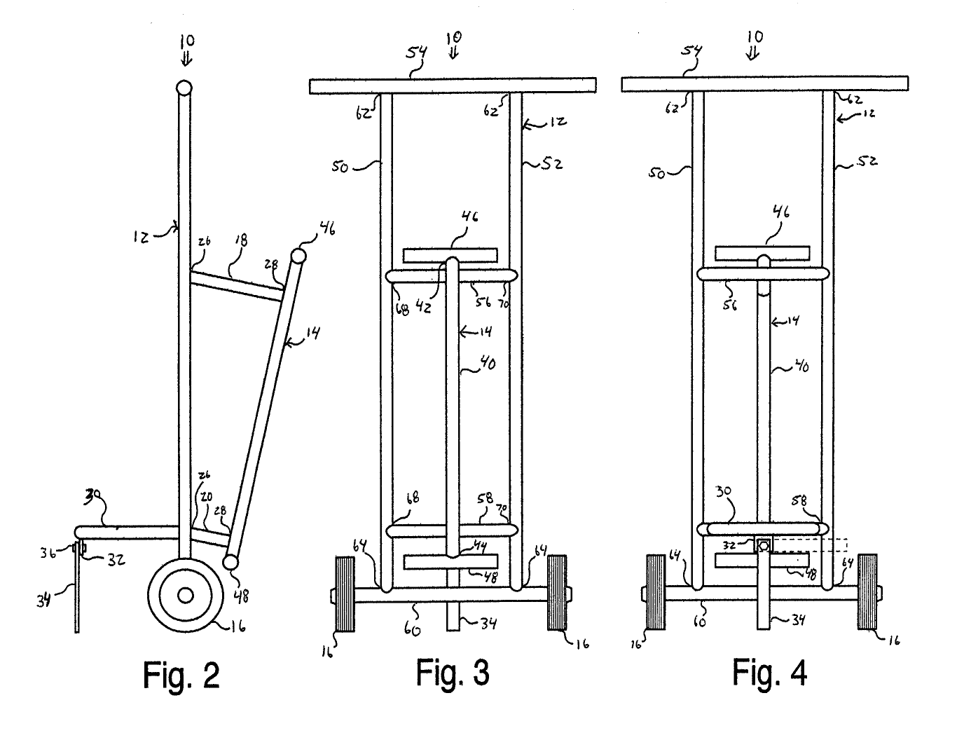

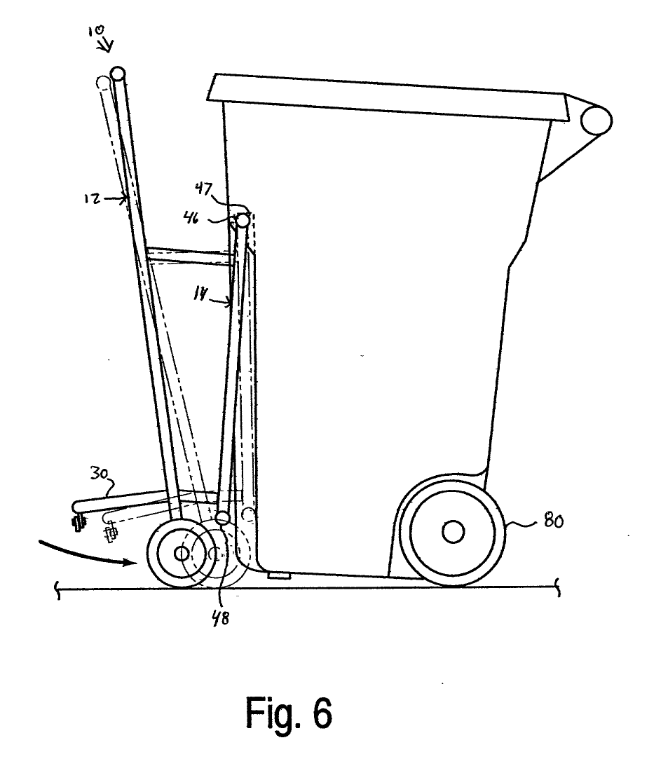

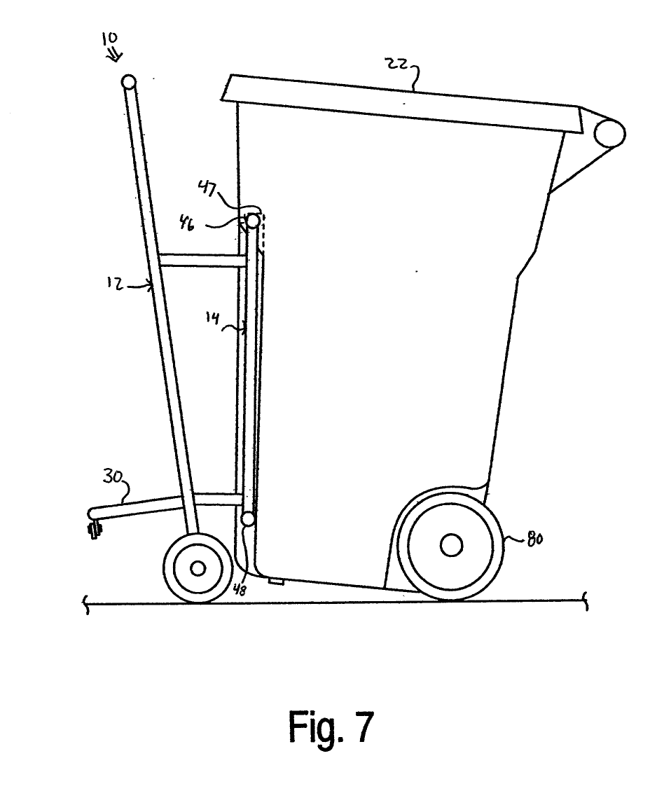

The dolly 10 will now be described in greater detail with reference to FIGS. 2-7. As can be seen in FIG. 2, the dolly 10 includes a handle unit 12 and a lift unit 14. First attachment bar 18 and second attachment bar 20 connect the handle unit 12 and the lift unit 14. Each attachment bar 18,20 has a first end 26 and a second end 28. The handle unit 12, lift unit 14 and first and second attachment bars 18,20 can be made of any material having sufficient strength to support the items being moved during transport. In a preferred embodiment, these elements are made of steel tubing.

The first end 26 of each of first attachment bar 18 and second attachment bar 20 is connected to the handle unit 12. Each of first attachment bar 18 and second attachment bar 20 preferably protrudes from the handle unit 12 at slightly less than a 90 degree angle, each of first attachment bar 18 and second attachment bar 20 pointing downward once connected. The second end 28 of each of first attachment bar 18 and second attachment bar 20 is connected to the lift unit 14. Each of first attachment bar 18 and second attachment bar 20 is preferably form a 90 degree angle with lift unit 14 when connected. In a preferred embodiment, first attachment bar 18 is longer than second attachment bar 20 so that when assembled lift unit 14 protrudes at an angle from handle unit 12 when handle unit 12 is upright.

In a preferred embodiment, a step bar 30 is connected to the handle unit 12. The step bar 30 is preferably substantially U-shaped as can be seen in FIG. 1. In a preferred embodiment, the step bar 30 is made of steel tubing, but any other suitable material can be used. The step bar 30 is connected substantially perpendicularly to handle unit 12 on the side of handle unit 12 opposite the first attachment bar 18 and second attachment bar 20 so that the open portion of the step bar 30 is attached to the handle unit 12. The step bar 30 can be attached to the handle unit 12 using any conventional means. In a preferred embodiment, the step bar 30 is welded to the handle unit 12.

In a further preferred embodiment, a connection tab 32 extends downwardly from step bar 30. The connection tab 32 is preferably connected to step bar 30 at the end of step bar 30 opposite handle unit 12. The connection tab 32 can be connected to the step bar 30 by any conventional means. In a preferred embodiment, the connection tab 32 is welded to the step bar 30.

A kick stand 34 is rotatably connected to connection tab 32. The kick stand 34 is preferably long enough to contact the ground when the lift unit 14 is substantially perpendicular to the ground. The kick stand 34 is rotatably connected to the connection tab 32 using any conventional means. In a preferred embodiment, a bolt 36 is used to connect kick stand 34 to connection tab 32. The kick stand 34 and connection tab 32 can be made of any material with sufficient strength to support the weight of the dolly. In a preferred embodiment, the kick stand 34 and connection tab 32 are metal tubes.

As can be seen more clearly in FIG. 3, the lift unit 14 includes a shaft 40 having a first end 42 and a second end 44 and first and second lift bars 46,48. In a preferred embodiment, each of these elements is substantially straight. The first attachment bar 18 and second attachment bar 20 are preferably connected to the shaft 40. The first attachment bar 18 and second attachment bar 20 can be connected to the shaft 40 by any conventional means, but in a preferred embodiment they are welded to the shaft 40.

The first lift bar 46 is connected perpendicularly to the first end 42 of the shaft 40. The second lift bar 48 is connected perpendicularly to the second end 44 of the shaft 40. The first lift bar 46 and second lift bar 48 can be connected to the shaft 40 by any conventional means. In a preferred embodiment, the first lift bar 46 and second lift bar 48 are welded to the shaft 40. In a preferred embodiment, the lift unit is configured to allow the first lift bar to fit 46 snugly within the Upper Lift Pocket 47 and allow the second lift bar 48 to fit snugly within the lower attachment points (not shown) of a typical commercial waste receptacle complying with ANSI standards for Waste Containers—Compatibility Dimensions.

The construction of the handle unit 12 can be more clearly seen with reference to FIGS. 3 and 4. The handle unit 12 includes left and right support bars 50, 52, a handle 54, first and second cross bar 56,58, and axle 60, each of which is substantially straight in the preferred embodiment. Each of left support bar 50 and right support bar 52 has a first end 62 and a second end 64. The first end 62 of each left support bar 50 and right support bar 52 is preferably perpendicularly connected to handle 54 so that when left support bar 50 and right support bar 52 are connected to handle 54, left support bar 50 and right support bar 52 are substantially parallel. In a preferred embodiment, when handle 54 is connected to left support bar 50 and right support bar 52, the length of handle 54 extends beyond left support bar 5oe 0 and right support bar 52. Handle 54 can be connected to left support bar 50 and right support bar 52 by any conventional means, but in a preferred embodiment handle 54 is welded to left support bar 50 and right support bar 52.

The second end 64 of each of left support bar 50 and right support bar 52 is preferably perpendicularly connected to axle 60. Left support bar 50 and right support bar 52 are connected to axle 60 by any conventional means, but in a preferred embodiment left support bar 50 and right support bar 52 are welded to axle 60. When connected, the length of axle 60 preferably extends beyond left support bar 50 and right support bar 52. Wheels 16 are preferably attached to axle 60 to facilitate movement of the dolly 10. In a preferred embodiment, a wheel 16 is preferably rotatably attached to each end of axle 60. However, any number of wheels can be used and the method and location of attachment will depend on the number of wheels. Any conventional manner for rotatably attaching wheels can be used, and many such methods are known in the art. In an alternate embodiment, instead of wheels a slippery “skid” is attached to axle 60. Such articles are commonly known in the art, and any such conventional article can be used.

Each of the first and second cross bars, 56 and 58 has a first end 68 and a second end 70. The first end 68 of first cross bar 56 is perpendicularly connected to left support bar 50 and the second end 70 of first cross bar 56 is perpendicularly connected to right support bar 52. The first end 68 of second cross bar 58 is perpendicularly connected to left support bar 50 and the second end 70 of second cross bar 58 is perpendicularly connected to right support bar 52. First cross bar 56 and second cross bar 58 are connected to left support bar 50 and right support bar 52 by any conventional means, but in a preferred embodiment the elements are welded together.

In a further preferred embodiment, first attachment bar 18 is connected to first cross bar 56 and second attachment bar 20 is connected to second cross bar 58. First and second attachment bars 18,20 can be connected to first and second cross bars 56,58 by any conventional means, but in a preferred embodiment first and second attachment bars 18,20 are welded to first and second cross bars 56,58. The step bar 30, if used, is preferably perpendicularly attached to second cross bar 58 so the step bar 30 can be easily accessed by the user. The step bar 30 can be attached to second cross bar 58 in any conventional manner, but in a preferred embodiment step bar 30 is welded to second cross bar 58.

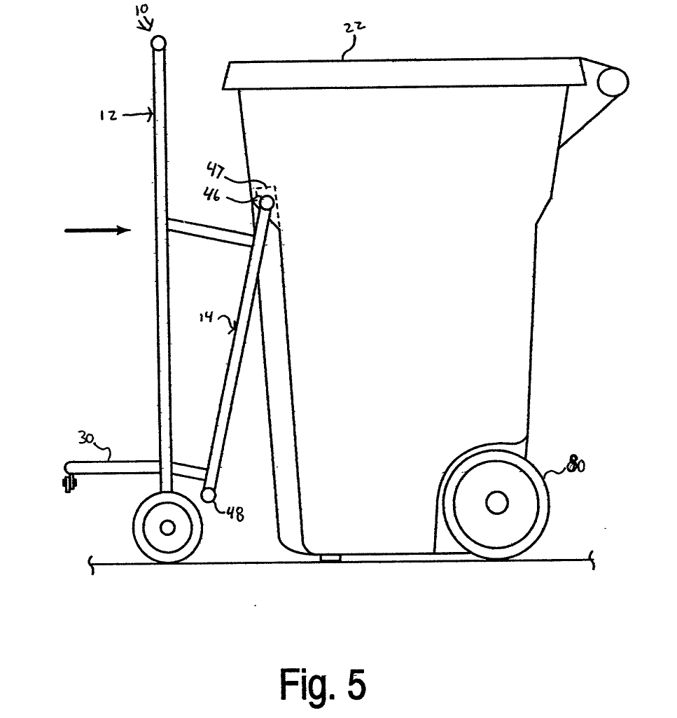

A method of using the dolly 10 is shown in FIGS. 5-7. While the use will be described with reference to a single waste receptacle, the invention is suitable for use with stacks of items as well. To use the dolly 10 with a typical commercial waste receptacle, the dolly 10 is first rolled to the stack. The lift unit 14 is placed in contact with the base waste receptacle 22 so the first lift bar 46 fits within the upper lift envelope 47. Using the handle unit 12, the dolly 10 is then tilted so the second lift bar 48 fits within the lower attachment points (not shown). This positioning will connect the stack to the dolly 10. The dolly 10 is then tilted further so only the wheels 80 of the waste receptacle 22 are in contact with the ground. The user can utilize the step bar 30, if present, to aid in tilting the dolly 10. After tilting the stack, the dolly 10 is pulled to move the items. The reverse process is used to place the stack in its new position.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said” is not to be construed as limiting the element to the singular.

The embodiments of the invention in which an exclusive property or privilege is claimed are defined as follows:

1. A dolly apparatus comprising:
a handle unit including a first support bar having a first end and a second end, a handle connected to said first end of said first support bar, an axle connected to said second end of said first support bar, and at least one wheel rotatably attached to said axle;
a lift unit including a shaft having a first end and a second end, a first lift bar attached to said first end of said shaft and a second lift bar attached to said second end of said shaft; and
a first attachment bar having a first end and a second end, said first end of said first attachment bar being attached to said handle unit and said second end of said first attachment bar being attached to said lift unit.

2. The dolly apparatus of claim 1, further including a second attachment bar having a first end and a second end, said first end of said second attachment bar being attached to said handle unit and said second end of said second attachment bar being attached to said lift unit.

3. The dolly apparatus of claim 2, further including a step bar attached to said handle unit.

4. The dolly apparatus of claim 3, further including a connection tab attached to said step bar and a kick stand rotatably connected to said connection tab.

5. The dolly apparatus of claim 4, wherein said kick stand is rotatably connected to said connection tab with a bolt.

6. The dolly apparatus of claim 2, further including a second support bar having a first end and a second said, said first end of said second support bar being attached to said handle and said second end of said second support bar being attached to said axle.

7. The dolly apparatus of claim 6, further including a first cross bar having a first end and a second end, said first end of said first cross bar being attached to said first support bar and said second end of said first cross bar being attached to said second support bar.

8. The dolly apparatus of claim 7, further including a second cross bar having a first end and a second end, said first end of said second cross bar being attached to said first support bar and said second end of said second cross bar being attached to said second support bar.

9. The dolly apparatus of claim 8, wherein said first attachment bar is attached to said first cross bar and said second attachment bar is attached to said second cross bar.

10. The dolly apparatus of claim 9, further including a step bar attached to said handle unit.

11. The dolly apparatus of claim 10, wherein said step bar is connected to said second cross bar.

12. The dolly apparatus of claim 11, further including a connection tab attached to said step bar and a kick stand rotatably connected to said connection tab.

13. The dolly apparatus of claim 12, wherein said kick stand is rotatably connected to said connection tab with a bolt.

14. A dolly apparatus comprising:
a handle unit including a first support bar having a first end and a second end, a handle connected to said first end of said first support bar, an axle connected to said second end of said first support bar, and at least one skid attached to said axle;
a lift unit including a shaft having a first end and a second end, a first lift bar attached to said first end of said shaft and a second lift bar attached to said second end of said shaft; and
a first attachment bar having a first end and a second end, said first end of said first attachment bar being attached to said handle unit and said second end of said first attachment bar being attached to said lift unit.

15. The dolly apparatus of claim 14, further including a second attachment bar having a first end and a second end, said first end of said second attachment bar being attached to said handle unit and said second end of said second attachment bar being attached to said lift unit.

16. The dolly apparatus of claim 15, further including a step bar attached to said handle unit.

17. The dolly apparatus of claim 16, further including a connection tab attached to said step bar and a kick stand rotatably connected to said connection tab.

18. The dolly apparatus of claim 17, wherein said kick stand is rotatably connected to said connection tab with a bolt.

19. The dolly apparatus of claim 15, further including a second support bar having a first end and a second said, said first end of said second support bar being attached to said handle and said second end of said second support bar being attached to said axle.

20. The dolly apparatus of claim 19, further including a first cross bar having a first end and a second end, said first end of said first cross bar being attached to said first support bar and said second end of said first cross bar being attached to said second support bar.

21. The dolly apparatus of claim 20, further including a second cross bar having a first end and a second end, said first end of said second cross bar being attached to said first support bar and said second end of said second cross bar being attached to said second support bar.

22. The dolly apparatus of claim 21, wherein said first attachment bar is attached to said first cross bar and said second attachment bar is attached to said second cross bar.

23. The dolly apparatus of claim 22, further including a step bar attached to said handle unit.

24. The dolly apparatus of claim 23, wherein said step bar is connected to said second cross bar.

25. The dolly apparatus of claim 24, further including a connection tab attached to said step bar and a kick stand rotatably connected to said connection tab.

26. The dolly apparatus of claim 25, wherein said kick stand is rotatably connected to said connection tab with a bolt.

27. A hand-operated, wheeled lifting device comprising:
a frame including an article support and a handle, the article support having an upper portion for engaging an article to be lifted, the frame having a lower portion;
a pair of wheels rotatably mounted on said lower portion of said frame and having an axis of rotation; and
wherein said device is movable between an insert position and a lift position, said upper portion of said article support and said handle being on opposite sides of a vertical plane through the axis when said device is in the insert position, said upper portion of said article support and said handle being on the same side of the vertical plane when the device is in the lift position.

28. The lifting device of claim 27, further including a step bar attached to said lower portion of said frame.

29. The lifting device of claim 28, further including a connection tab attached to said step bar and a kick stand rotatably attached to said connection tab.

30. The lifting device of claim 29, wherein said kick stand is rotatably attached to said connection tab with a bolt.
